(19) United States
(12) Patent Application Publication
(10) Pub. No.: US 2020/0320904 A1
(43) Pub. Date: Oct. 8, 2020

(54) PRODUCT INDICIA MOLDING

(71) Applicant: Nashville Wire Products Manufacturing Company, LLC, Nashville, TN (US)

(72) Inventors: John Nicholas Phy, Pegram, TN (US); William Jacob Johnson, Spring Hill, TN (US); Jammie Todd Allbert, White Bluff, TN (US); James Thomas Baggett, Clarksville, TN (US)

(21) Appl. No.: 16/372,574

(22) Filed: Apr. 2, 2019

(51) Int. Cl. G09F 3/20; A47F 5/00; A47F 5/01

(52) U.S. Cl. CPC G09F 3/204; A47F 5/0056; A47F 5/01; A47F 5/0068

(57) ABSTRACT

An apparatus for attachment to a shelf and a system thereof are disclosed herein. The shelf includes at least parallel upper and lower front wires. The apparatus comprises a connector, a stop plate receiver, and a product indicia receiver channel. The connector includes upper and lower partially circular channels configured to receive the spaced parallel upper and lower front wires of the shelf. The stop plate receiver is integrally formed with the connector and includes an upwardly open channel configured to receive a stop plate. The product indicia receiver channel is integrally formed with the connector and the stop plate receiver. The product indicia receiver channel is located forward of the connector and is configured to receive product indicia. The stop plate receiver channel may be positioned between the connector and the product indicia receiver channel or may be positioned rearward of the connector.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present disclosure relates generally to product indicia receivers used in conjunction with the display of retail merchandise on shelves, such as gravity-feed or horizontal shelving. More particularly, this disclosure pertains to product indicia moldings for use along a front edge of a shelf of a retail display shelving unit.

### 2. Description of the Prior Art

Merchandise shelves commonly found in supermarkets and the like generally provide a product indicia receiver channel along the front edge. Such merchandising shelves can also be modified to include a product indicia molding attached along the front edge. Such product indicia moldings and receiver channels have upper and lower flanges that can be used to accommodate snap-in product indicia labels that correspond to merchandise positioned on the shelf. The types of information provided on product indicia labels may include price, product name, and a barcode just to name a few.

Depending on the type of shelving the product indicia molding configuration may be different. Various product indicia moldings for attachment to the front edge of a shelf are currently available on the market. Product indicia moldings may be configured to fit on shelves that are oriented horizontally or that are angled for gravity-feed applications.

Shelves that are configured for gravity-feed applications typically include a front stop plate that stops merchandise from sliding off the shelf. These stop plates are typically positioned rearward from both the product indicia molding and the front edge of the shelf. Stop plates can be attached directly to the shelf or to shelf dividers configured to divide the shelf into lanes. When the stop plate is mounted directly to the shelf it may interfere with the shelf dividers. When the stop plate is mounted to the shelf dividers, it may make adjustment of the lanes sizes more difficult because it must be removed prior to adjustment. The stop plate, when attached to the shelf dividers or the shelf itself, may also interfere with the product indicia molding.

### BRIEF DESCRIPTION

Accordingly, a need exists for a new product indicia molding that does not interfere with and is not interfered with by the stop plate. More preferably, a need exists for a new product indicia molding that includes a stop plate receiver for receiving the stop plate. Such a product indicia molding allows for a cleaner look along the front edge of the shelf and solves many of issues associated with separate stop plates and product indicia moldings. The present disclosure provides an apparatus (e.g., a product indicia molding) and a shelving system that includes the product indicia molding. The product indicia molding as disclosed herein includes a connector, a stop plate receiver, and a product indicia receiver channel. The connector, the stop plate receiver, and the product indicia receiver channel are all integrally formed to thereby add strength and simplify the various attachments associated with the front edge of the shelf.

According to one aspect of the present disclosure, there is provided a shelving system comprised of a shelf and a product indicia molding including a connector, a stop plate receiver, and a product indicia receiver channel. The shelf includes a front top rail and a front bottom rail. The product indicia molding is configured to extend from the shelf. The connector includes an upper connector channel that is configured to receive an upper portion of the front top rail. The stop plate receiver is integrally formed with the connector and includes an upwardly open channel that is configured to receive a stop plate. The product indicia receiver channel is integrally formed with the connector and the stop plate receiver. The product indicia receiver channel is located forward of the connector and is configured to receive product indicia.

According to another aspect of the shelving system of the present disclosure, the stop plate receiver may be located forward of the connector between the connector and the product indicia receiver channel.

According to another aspect of the shelving system of the present disclosure, a receiver wall may be defined between the stop plate receiver and the product indicia receiver channel. The receiver wall may include a receiver side and an indicia side. The receiver side may define a portion of the stop plate receiver. The indicia side may be angled upward relative to the receiver side.

According to another aspect of the shelving system of the present disclosure, the stop plate receiver may include a floor positioned closer to a lowermost portion of the connector than to an uppermost portion of the connector.

According to another aspect of the shelving system of the present disclosure, the stop plate receiver may be located rearward of the connector.

According to another aspect of the shelving system of the present disclosure, a connector wall may be defined between the connector and the product indicia receiver channel. The connector wall may include a connector side and an indicia side. The connector side may define a portion of the connector. The indicia side may be angled upward relative to the connector side.

According to another aspect of the shelving system of the present disclosure, the stop plate receiver may include a rear wall extending higher than the upper connector channel.

According to another aspect of the shelving system of the present disclosure, the connector may include a lower connector extension that is configured to engage a lower portion of the front bottom rail.

According to another aspect of the shelving system of the present disclosure, the stop plate receiver may include a floor being offset vertically relative to a lower interior portion of the lower connector extension by an offset.

According to another aspect of the shelving system of the present disclosure, the offset may be greater than or equal to 1 mm and less than or equal to 25.4 mm.

According to another aspect of the shelving system of the present disclosure, the shelf may include a plurality of balls positioned between the front top rail and the front bottom rail.

According to another aspect of the shelving system of the present disclosure, the connector may include an indentation defined between an uppermost portion of the connector and a lowermost portion of the connector for receiving a portion of each ball of the plurality of balls.

According to another aspect of the shelving system of the present disclosure, the stop plate may be received in the stop plate receiver. The stop plate may include an upper portion and a lower portion. The lower portion may be oriented perpendicular to the shelf when the stop plate is received in the stop plate receiver.

According to another aspect of the shelving system of the present disclosure, the upper portion may be angled rearward at a stop plate angle relative to the lower portion.

According to another aspect of the shelving system of the present disclosure, the shelf may have a width and the product indicia molding may include a molding length. The molding length may be less than or equal to the width of the shelf.

According to further aspects of the present disclosure, there is provided an apparatus for attachment to a shelf including spaced parallel upper and lower front wires. The apparatus is comprised of a connector, a stop plate receiver, and a product indicia receiver channel. The connector includes a connector wall and an upper partially circular channel extending from the connector wall. The upper partially circular channel is configured to receive the upper front wire of the shelf. The connector wall is configured to engage the spaced parallel upper and lower front wires of the shelf. The stop plate receiver is integrally formed with the connector and includes an upwardly open channel that is configured to receive a stop plate. The product indicia receiver channel is integrally formed with the connector and the stop plate receiver. The product indicia receiver channel is located forward of the connector and is configured to receive product indicia.

According to another aspect of the apparatus of the present disclosure, the stop plate receiver may be located forward of the connector between the connector and product indicia receiver channel.

According to another aspect of the apparatus of the present disclosure, the stop plate receiver may include a receiver floor. The receiver floor may be positioned higher than a lowermost extremity of the connector.

According to another aspect of the apparatus of the present disclosure, a receiver wall may be defined between the stop plate receiver and the product indicia receiver channel. The receiver wall may include a receiver side and an indicia side. The receiver side may define a portion of the upwardly open channel of the stop plate receiver. The indicia side may be angled upwardly relative to the connector.

According to another aspect of the apparatus of the present disclosure, the receiver wall may include a variable thickness that is defined between the receiver side and the indicia side. The variable thickness may be configured to angle the indicia side upwardly relative to the receiver side.

According to another aspect of the apparatus of the present disclosure, the stop plate receiver may be located rearward of the connector. The connector wall may be defined between the connector and the product indicia receiver channel. The connector wall may include a connector side, an indicia side, and a variable thickness defined between the connector side and the indicia side. The upper partially circular channel may extend from the connector side. The variable thickness may be configured to angle the indicia side upwardly relative to the connector side.

According to another aspect of the apparatus of the present disclosure, the connector may include a lower partially circular channel that extends from the connector wall and configured to receive the lower front wire of the shelf.

### BRIEF DESCRIPTION OF THE SEVERAL VIEWS OF THE DRAWINGS

FIG. 1 is a perspective view of a shelving system including a shelf and a product indicia molding in accordance with a first embodiment of the present disclosure.

FIG. 2 is an enlarged perspective view of the shelving system of FIG. 1 taken of area 2 of FIG. 1.

FIG. 3 is a cross-sectional side elevation view of the shelving system of FIG. 1 taken along line 3-3 of FIG. 1.

FIG. 4A is an enlarged side elevational view of the shelving system of FIG. 3 taken of area 4A of FIG. 3.

FIG. 4B is a side elevation view of the shelving system of FIG. 4A with the shelf including a front bottom retainer wire.

FIG. 5 is a perspective view of the product indicia molding of the shelving system of FIG. 1.

FIG. 6A is a cross-sectional side elevation view of the product indicia molding of FIG. 5 taken along line 6A-6A of FIG. 5.

FIG. 6B is a side elevation view of an alternate embodiment of the product indicial molding of FIG. 6A having a lower connector channel removed in accordance with the present disclosure.

FIG. 7 is a perspective view of the shelving system including the shelf and a product indicia molding in accordance with a second embodiment of the present disclosure.

FIG. 8 is an enlarged perspective view of the shelving system of FIG. 7 taken of area 8 of FIG. 7.

FIG. 9 is a cross-sectional side elevation view of the shelving system of FIG. 7 taken along line 9-9 of FIG. 7.

FIG. 10A is an enlarged side elevational view of the shelving system of FIG. 9 taken of area 10A of FIG. 9.

FIG. 10B is a side elevation view of the shelving system of FIG. 10A with the shelf including a front bottom retainer wire.

FIG. 11 is a perspective view of the product indicia molding of the shelving system of FIG. 7.

FIG. 12 is a cross-sectional side elevation view of the product indicia molding of FIG. 11 taken along line 12-12 of FIG. 11.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

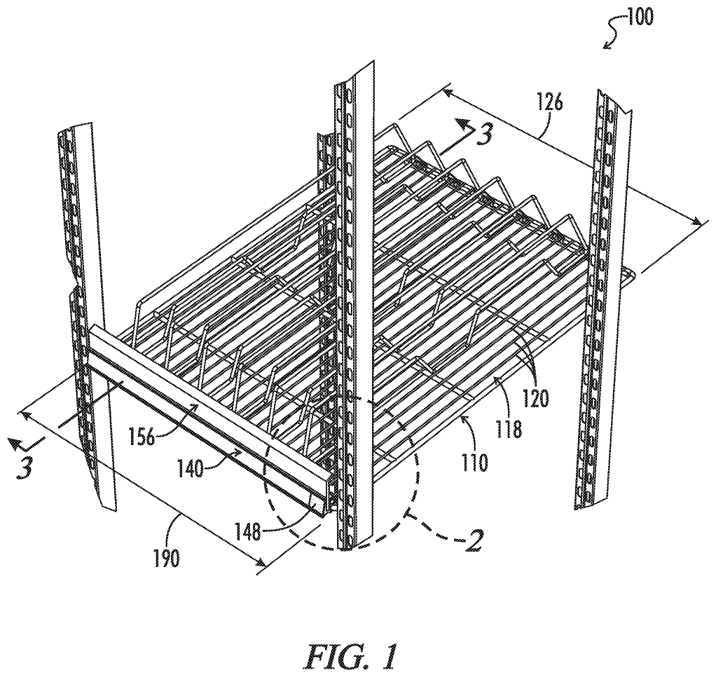

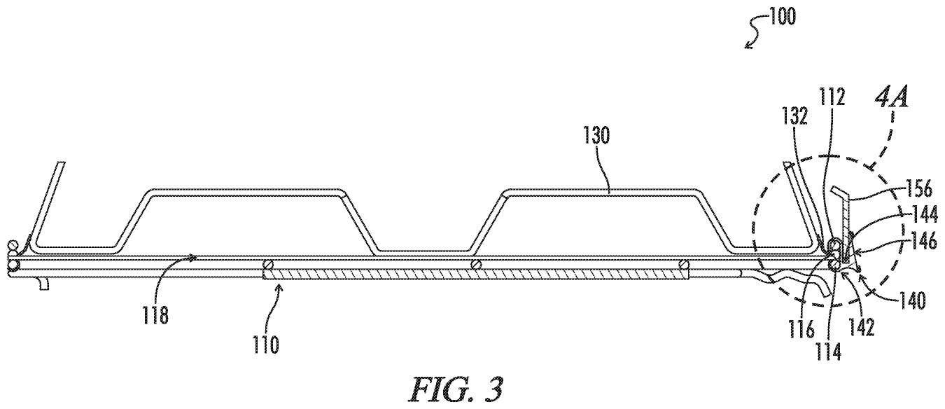

Referring to FIGS. 1-4B, a first embodiment of a shelving system 100 is provided. The shelving system 100 includes a shelf 110 and a product indicia molding 140 being configured to attach to and extend from the shelf 110. The product indicia molding 140 may also be referred to herein as an apparatus 140 for attachment to the shelf 110 or a price tag molding 140. The shelving system 100 may be implemented horizontally or may be angled such that it is able to gravity-feed products towards the lowest portion of the shelf 110.

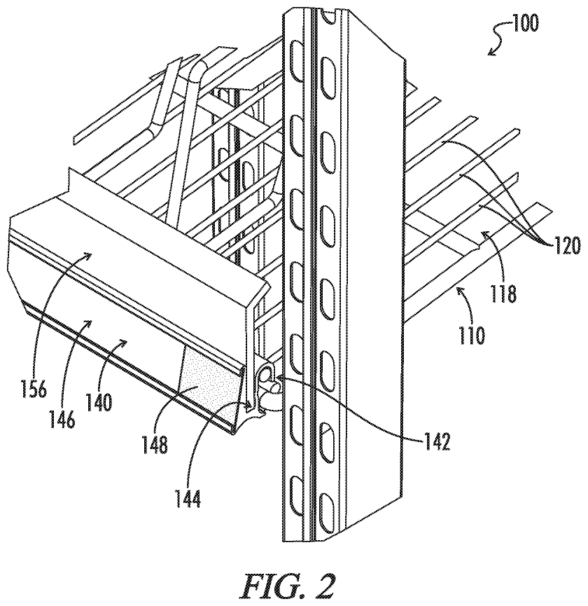

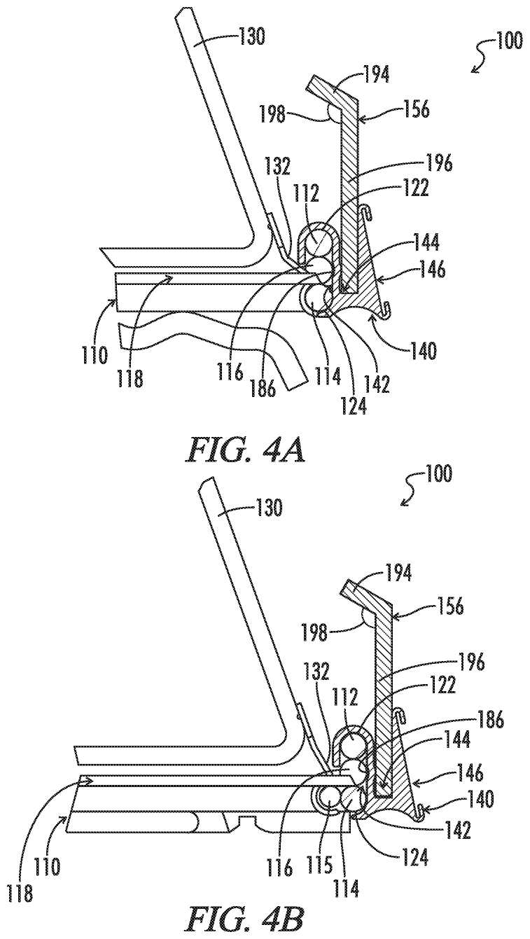

As can best be seen in FIGS. 2-4B, the shelf 110 includes a front top rail 112 and a front bottom rail 114. The front top rail 112 may also be referred to herein as an upper front wire 112. The front bottom rail 114 may also be referred to herein as a lower front wire 114. The front top and bottom rails 112, 114 are positioned parallel to each other and are spaced apart. As can best be seen in FIG. 4B, the shelf 110 may include a front bottom retainer wire 115 positioned rearward and connected to the front bottom rail 114.

The shelf 110 may further include a plurality of balls 116 separating the front top rail 112 and the front bottom rail 114. Each ball of the plurality of balls 116 may have a diameter larger than, smaller than, or similar in size to that of the front top rail 112 and the front bottom rail 114. The use of the plurality of balls 116 may provide manufacturing cost reductions as compared with alternative spacing options that may utilize an additional wire (not shown) for spacing the front top rail 112 apart from the front bottom rail 114.

The shelf 110 may still further include a support portion 118 supported on the front bottom rail 114. The support portion 118 may comprise a plurality of support wires 120 positioned parallel to each other and spaced apart. The plurality of support wires may be positioned perpendicularly to the front top rail 112 and the front bottom rail 114.

As can best be seen in FIGS. 2-6A, the product indicia molding 140 includes a connector 142, a stop plate receiver 144, and a product indicia receiver channel 146 for receiving product indicia 148 (shown in FIGS. 1-2 and 7-8). The product indicia molding 140 may be made from an extruded or molded aluminum. In other embodiments, the product indicia molding 140 may be made from some other metal or some other material such as plastic, polycarbonate, or the like.

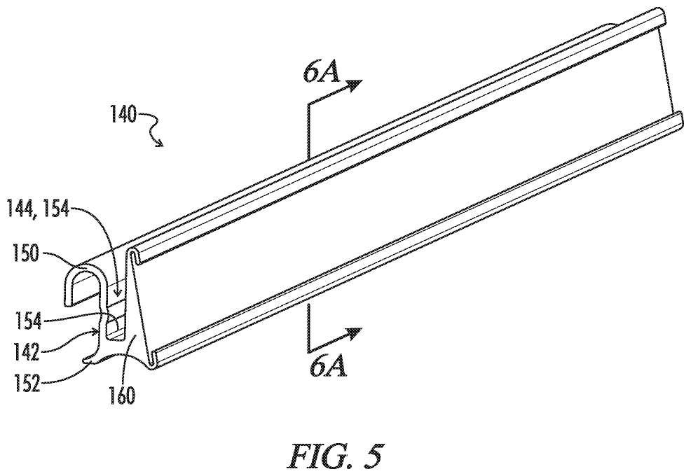

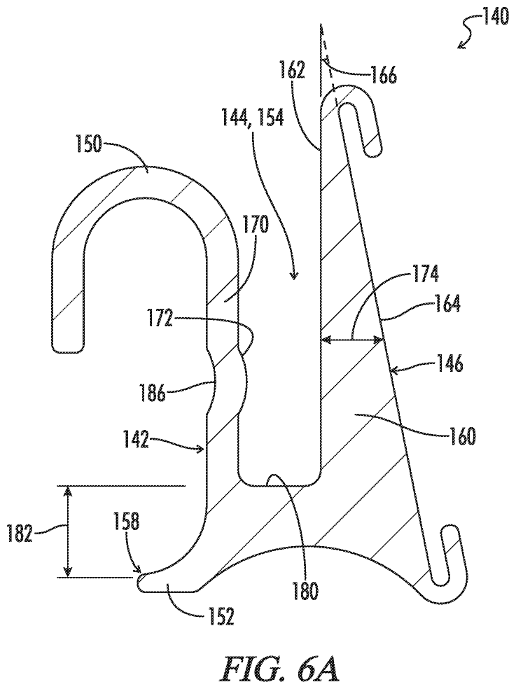

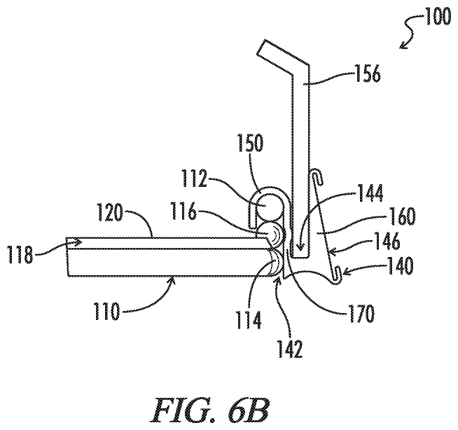

As can best be seen in FIGS. 5-6A, the connector 142 includes an upper connector channel 150 and a lower connector channel 152. The upper connector channel 150 may also be referred to herein as an upper partially circular channel 150. The lower connector channel 152 may also be referred to herein as a lower partially circular channel 152 or a lower connector extension 152. The upper and lower connector channels 150, 152 may be partially circular and be configured to receive the front top rail 112 and the front bottom rail 114. As can best be seen in FIGS. 4A-4B, the upper connector channel 150 may be configured to receive an upper portion 122 of the front top rail 112. The lower connector channel 152 may be configured to engage a lower portion 124 of the front bottom rail 114.

The stop plate receiver 144 is integrally formed with the connector 142. As can best be seen in FIG. 6A, the stop plate receiver 144 may include an upwardly open channel 154 that is configured to receive a stop plate 156. The stop plate 156 may be made out of any suitable material such as plastic, metal, alloy, polymer, or the like. Ideally, the stop plate 156 is made from a transparent material so that the products (not shown) positioned on the shelf 110 and their respective labels may be fully viewable by consumers (not shown).

The product indicia receiver channel 146 is integrally formed with the connector 142 and the stop plate receiver 144. The product indicia channel 146 is located forward of the connector 142 and the stop plate receiver 144. As can best be seen in FIG. 1-2, the product indicia receiver channel 146 is configured to receive the product indicia 148 which may include product specific information such as pricing, the product name, and barcode information corresponding to products (not shown) positioned on the shelf 110 that align with the product indicia 148. The product indicia receiver channel 146 may include upper and lower flanges configured to engage and securely hold the product indicia.

The product indicia molding 140 has the stop plate receiver 144 located forward of the connector 142 between the connector 142 and the product indicia receiver channel 146. As can best be seen in FIG. 6A, a receiver wall 160 may be defined between the stop plate receiver 144 and the product indicia receiver channel 142. The receiver wall 160 may include a receiver side 162 and an indicia side 164. The receiver side 162 may define a portion of the stop plate receiver 144. Specifically, the receiver side may define a portion of the upwardly open channel 154 of the stop plate receiver 144. The indicia side 164 may be angled upward relative to the connector 142 at an angle 166. The angle 166 may be greater than 0 degrees and less than or equal to 30 degrees.

The product indicia molding 140 may further include a rearward wall 170 positioned between the stop plate receiver 144 and the connector 142. The rearward wall 170 may also be referred to herein as a connector wall 170. The rearward wall 170 may be configured parallel to and spaced apart from the receiver wall 160. The rearward wall 170 may include a protrusion 172 extending from an interior surface of the rearward wall 170 toward the receiver wall 160 for engaging the stop plate 156 when received by the stop plate receiver 144. The protrusion 172 may be partially circular. An exterior surface of the rearward wall 170 may define a portion of the connector 142. The exterior surface of the rearward wall 170 may be configured to engage the front top rail 112 and the front bottom rail 114 when the front top rail 112 receives the upper connector channel 150.

The receiver wall 160 may include a variable thickness 174 defined between the receiver side 162 and the product indicia side 164. The variable thickness 174 may be configured to angle the indicia side 164 relative to the receiver side 162 of the receiver wall 160 at the angle 166. In other embodiments (not shown), the rearward wall 170 may alternatively and/or in addition to include a variable thickness configured to angle the indicia side 164 upwardly relative to the connector 142.

As can best be seen in FIGS. 1-4B, the product indicia molding 140 having the stop plate receiver 144 positioned between the connector 142 and the product indicia receiver channel 146 is compatible with a shelf divider 130. The shelf divider 130 may have a clip 132 extending from an end of the shelf divider 130. As can best be seen in FIG. 4A, the clip 132 is configured to engage the front bottom rail 114. The clip 132 may engage a rear portion of the front bottom rail 114. The clip 132 may further be configured to abut the lower connector channel 152 of the connector 142 along the lower portion 124 of the front bottom rail 114. As can best be seen in FIG. 4B, the clip 132 is also configured to be able to engage the front bottom retainer wire 115 when implemented as part of the shelf 110.

As can best be seen in FIG. 6A, the stop plate receiver 144 may include a floor 180. The floor 180 may be connected between the receiver wall 160 and the rearward wall 170. The floor 180 may be positioned closer to the lower connector channel 152 than to the upper connector channel 150. In other words, the floor 180 may be positioned closer a lowermost portion (e.g., the lower connector channel 152 or a lower portion the exterior surface of the rearward wall 170) of the connector 142 than to an uppermost portion (e.g., the upper connector channel 150 or an upper portion of the exterior surface of the rearward wall 170) of the connector 142. The floor 180 may be positioned higher than a lowermost extremity of the connector 142 (e.g., an interior or exterior surface of the lower connector channel 152). The floor 180 is configured to support the stop plate 156 when the stop plate 156 is received by the stop plate receiver 144. The floor 180 is offset vertically relative to a lower interior portion 158 of the lower connector channel 152 by an offset 182. The offset 182 may be greater than or equal to 1 mm and less than or equal to 25.4 mm.

As can best be seen in FIGS. 4A, 4B, and 6A, the connector 142 of the product indicia molding 140 may include an indentation 186 defined between the upper connector channel 150 and the lower connector channel 152. In order words, the indentation may be defined between the lowermost portion of the connector 142 and the uppermost portion of the connector 142. The indentation 186 may be partially circular. The indentation 186 may be configured to receive a portion of each ball of the plurality of balls 116. The indentation 186 may ensure that the connector 142 is able to fully engage the front top rail 112 and the front bottom rail 114 of the shelf 110. The indentation 186 may align with the protrusion 172 that extends into the upwardly open channel 154 of the stop plate receiver 144 for engaging the stop plate 156 when received by the upwardly open channel 154.

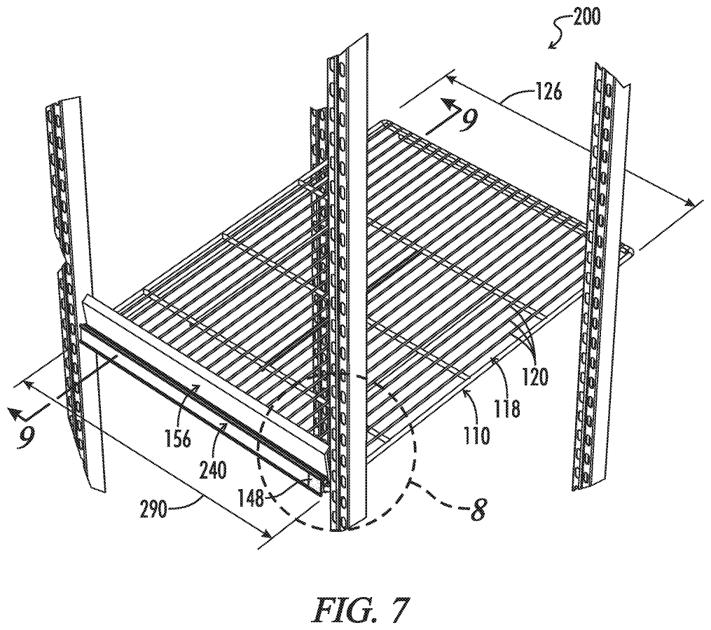

As can best be seen in FIGS. 1 and 7, the shelf 110 may include a shelf width 126. As can best be seen in FIG. 1, the product indicia molding 140 may include a molding length 190. Lengths of the connector 142, the stop plate receiver 144, and the product indicia receiver channel 146 may be substantially equal to the molding length 190. The molding length 190 may be less than or equal to the shelf width 126. Accordingly, the product indicia 148 may be attached to the product indicia receiver channel 146 at any point along the shelf width 126 to align with a product (not shown) positioned on the shelf 110.

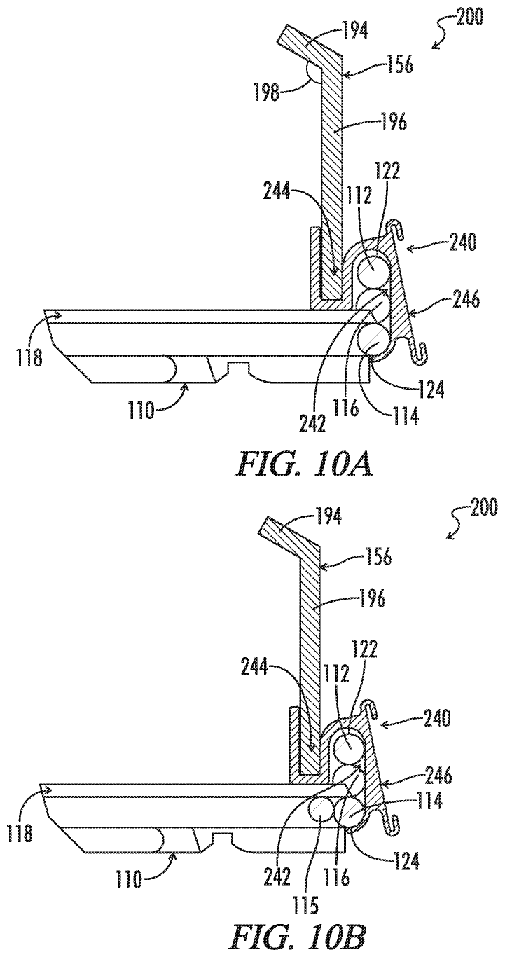

As can best be seen in FIGS. 4A, 4B, 10A, and 10B, the stop plate 156 may include an upper portion 194 and a lower portion 196. The lower portion 196 of the stop plate 156 is configured to be oriented perpendicular to the shelf 110 when the stop plate 156 is received by the stop plate receiver 144 and the connector 142 of the product indicia molding 140 is coupled to the shelf 110.

The upper portion 194 of the stop plate 156 may be angled rearward (e.g., over the shelf 110) at a stop plate angle 198 relative to the lower portion 196 of the stop plate 156. The upper portion 194 may be configured to engage products positioned on the shelf 110, especially when the shelf is oriented as a gravity-feed shelf. The stop plate angle 198 may be greater than 0 degrees and less than or equal to 45 degrees.

In certain embodiments, as can best be seen in FIG. 6B, the product indicia molding 140 may have the lower connector channel 152 removed. In such embodiments, a lower portion of the connector 142 (e.g., a lower portion the exterior surface of the rearward wall 170) may rest against the front bottom rail 114 when the front top rail 112 is received by the upper connector channel 150 of the connector 142. Products (not shown) resting upon the shelf 110 may interact with the stop plate 156, when the stop plate 156 is received by the stop plate receiver 144, to cause the lower portion of the connector 142 to remain in contact with the front bottom rail 114.

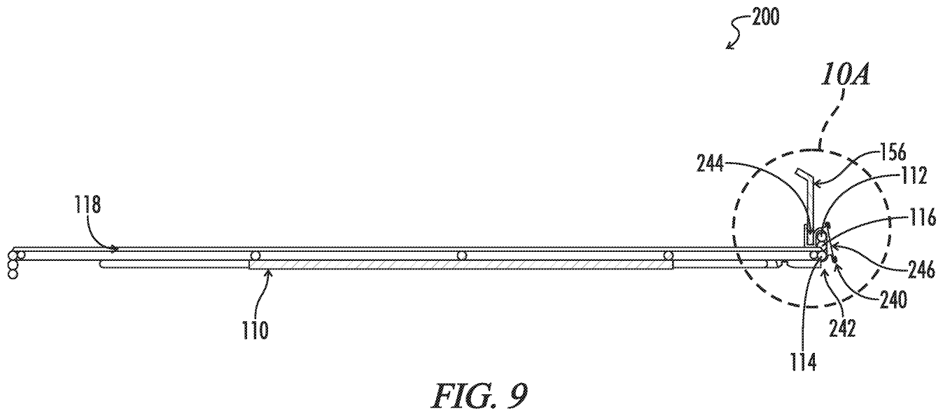

Referring to FIGS. 7-10B, a second embodiment of a shelving system 200 is provided. The shelving system 200 includes the shelf 110 and a product indicia molding 240 being configured to attach to and extend from the shelf 110. The product indicia molding 240 may also be referred to herein as a price tag molding 240 or an apparatus 240 for attachment to the shelf 110. The shelving system 200 may be implemented horizontally or may be angled such that it is able to gravity-feed products towards the lowest portion of the shelf 110.

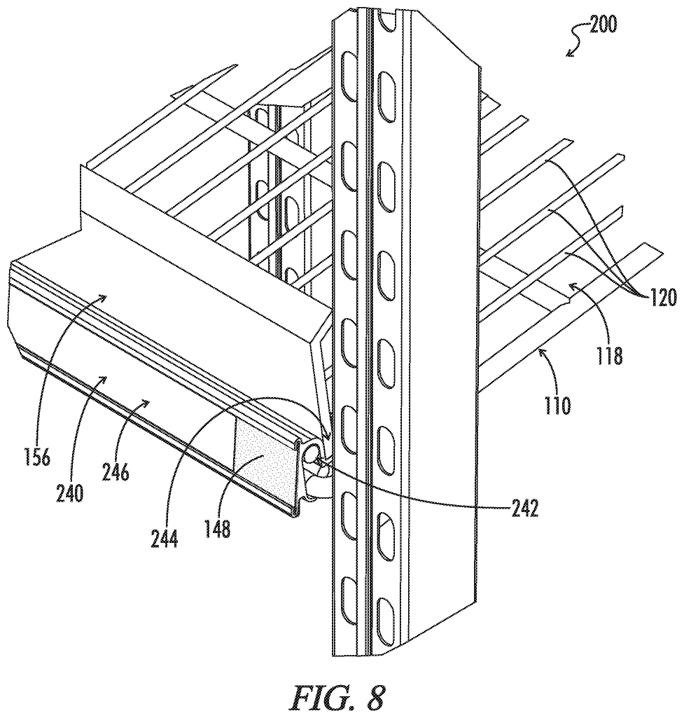

As can best be seen in FIGS. 8-12, the product indicia molding 240 includes a connector 242, a stop plate receiver 244, and a product indicia receiver channel 246 for receiving the product indicia 148 (shown in FIGS. 1-2 and 7-8). The product indicia molding 240 may be made from an extruded or molded aluminum. In other embodiments, the product indicia molding 240 may be made from some other metal or some other material such as plastic, polycarbonate, or the like.

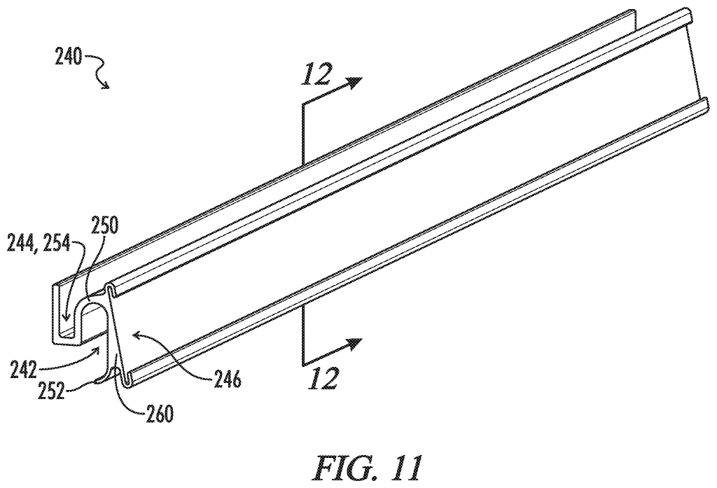

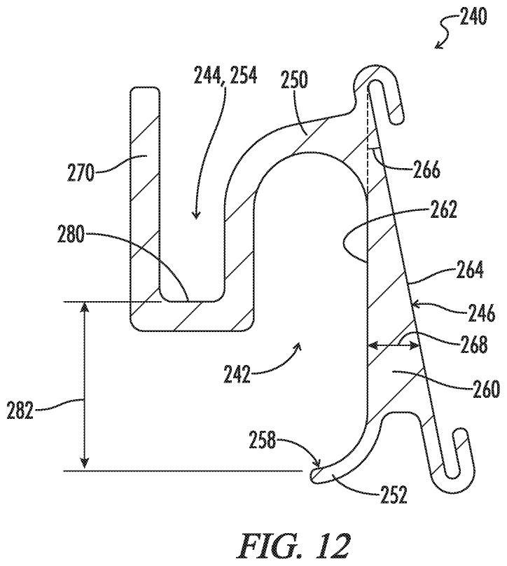

As can best be seen in FIGS. 11 and 12, the connector 242 includes an upper connector channel 250 and a lower connector channel 252. The upper connector channel 250 may also be referred to herein as an upper partially circular channel 250. The lower connector channel 252 may also be referred to herein as a lower partially circular channel 252 or a lower connector extension 252. The upper and lower connector channels 250, 252 may be partially circular and be configured to receive the front top rail 212 and the front bottom rail 214. As can best be seen in FIGS. 10A and 10B, the upper connector channel 250 may be configured to receive the upper portion 122 of the front top rail 112. The lower connector channel 252 may be configured to engage the lower portion 124 of the front bottom rail 114.

The stop plate receiver 244 is integrally formed with the connector 242. As can best be seen in FIG. 12, the stop plate receiver 244 may include an upwardly open channel 254 that is configured to receive the stop plate 156.

The product indicia receiver channel 246 is integrally formed with the connector 242 and the stop plate receiver 244. The product indicia channel 246 is located forward of the connector 242 and the stop plate receiver 144. As can best be seen in FIGS. 7 and 8, the product indicia receiver channel 246 is configured to the receive product indicia 148 which may include product specific information such as pricing, the product name, and barcode information corresponding to products (not shown) positioned on the shelf 210 that align with the product indicia 148. The product indicia receiver channel 246 may include upper and lower flanges configured to engage and securely hold the product indicia.

The product indicia molding 240 has the stop plate receiver 244 located rearward of the connector 242. Accordingly, the stop plate receiver 244 is located on an opposite side of the connector 242 with respect to the product indicia receiver channel 246. As can best be seen in FIG. 12, a connector wall 260 may be defined between the connector 242 and the product indicia receiver channel 246. The connector wall 260 may include a connector side 262 and an indicia side 264. The connector side 262 defines a portion of the connector 242. For example, the connector side 262 includes the upper and lower connector channels 250, 252 extending therefrom. The indicia side 264 may be angled upward at an angle 266 relative to the connector side 262. The angle 266 may be greater than 0 degrees and less than or equal to 30 degrees.

The connector wall 260 may include a variable thickness 268 defined between connector side 262 and the indicia side 264. The variable thickness 268 is configured to angle the indicia side 264 upwardly relative to the connector side 262 at the angle 266.

As can best be seen in FIG. 12, the stop plate receiver 244 may include a rearward-most wall 270 that extends higher than the upper connector channel 250. The rearward-most wall 270 may also be referred to herein as a rearward wall 270 or a rear wall 270.

As can best be seen in FIG. 12, the stop plate receiver 144 may include a floor 280. The floor 280 may be coupled between the rearward-most wall 270 and the upper connector channel 250 of the connector 242. The floor 280 may be positioned higher than a lowermost extremity of the connector 242 (e.g., an interior or exterior surface of the lower connector channel 252). The floor 280 is configured to support the stop plate 156 when the stop plate 156 is received by the stop plate receiver 244. The floor 280 is offset vertically relative to a lower interior portion 258 of the lower connector channel 252 by an offset 282. The offset 282 may be greater than or equal to 1 mm and less than or equal to 25.4 mm.

As can best be seen in FIG. 7, the product indicia molding 240 may include a molding length 290. Lengths of the connector 242, the stop plate receiver 244, and the product indicia receiver channel 246 may be substantially equal to the molding length 290. The molding length 290 may be less than or equal to the shelf width 126. Accordingly, the product indicia 148 may be attached to the product indicia receiver channel 246 at any point along the shelf width 126 to align with a product positioned on the shelf 110.

In certain embodiments (not shown), the product indicia molding 240 may include a protrusion and an indentation similar to the protrusion 172 and the indentation 186 of the product indicia molding 140.

In certain embodiments (not shown), the product indicia molding 240 may have the lower connector channel 152 removed similar to the product indicia molding 140 of FIG. 6B.

The previous detailed description has been provided for the purposes of illustration and description. Thus, although there have been described particular embodiments of a new and useful invention, it is not intended that such references be construed as limitations upon the scope of this invention except as set forth in the following claims.

1. A shelving system comprising:
a shelf including a front top rail and a front bottom rail, the front top rail spaced apart from the front bottom rail; and
a product indicia molding configured to extend from the shelf, the product indicia molding including:
a connector including an upper connector channel configured to receive an upper portion of the front top rail;
a stop plate receiver integrally formed with the connector and including an upwardly open channel configured to receive a stop plate;
a product indicia receiver channel integrally formed with the connector and the stop plate receiver, the product indicia receiver channel being located forward of the connector and configured to receive product indicia; and
a solid forwardmost wall of variable thickness positioned adjacent to and rearward of the product indicia receiver channel, the solid forwardmost wall of variable thickness including an indicia side defining a portion of the product indicia receiver channel.

2. The shelving system of claim 1, wherein:
the stop plate receiver is located forward of the connector and between the connector and the product indicia receiver channel.

3. The shelving system of claim 2, wherein:
the solid forwardmost wall of variable thickness comprises a receiver wall defined between the stop plate receiver and the product indicia receiver channel;
the receiver wall includes a receiver side and the indicia side, the receiver side defining a portion of the stop plate receiver; and
the indicia side of the receiver wall is angled upward relative to the receiver side due to the variable thickness between the receiver side and the indicia side.

4. The shelving system of claim 2, wherein:
the stop plate receiver includes a floor positioned closer to a lowermost portion of the connector than to an uppermost portion of the connector.

5. The shelving system of claim 1, wherein:
the stop plate receiver is located rearward of the connector.

6. The shelving system of claim 5, wherein:
the solid forwardmost wall of variable thickness comprises a connector wall defined between the connector and the product indicia receiver channel;
the connector wall includes a connector side and the indicia side, the connector side defining a portion of the connector; and
the indicia side of the connector wall is angled upward relative to the connector side due to the variable thickness between the connector side and the indicia side.

7. The shelving system of claim 5, wherein:
the stop plate receiver includes a rear wall of the upwardly open channel extending higher than the upper connector channel.

8. The shelving system of claim 1, wherein:
the connector includes a lower connector extension configured to engage a lower portion of the front bottom rail.

9. The shelving system of claim 8, wherein:
the stop plate receiver includes a floor being offset vertically relative to a lower interior portion of the lower connector extension by an offset.

10. The shelving system of claim 9, wherein:
the offset is greater than or equal to 1 mm and less than or equal to 25.4 mm.

11. The shelving system of claim 1, wherein:
the shelf includes a plurality of balls positioned between the front top rail and the front bottom rail.

12. The shelving system of claim 11, wherein:
the connector includes an indentation defined between an uppermost portion of the connector and a lowermost portion of the connector for receiving a portion of each ball of the plurality of balls.

13. The shelving system of claim 1, further comprising:
the stop plate received in the stop plate receiver, the stop plate including an upper portion and a lower portion, the lower portion being oriented perpendicular to the shelf when the stop plate is received in the stop plate receiver, the upper portion angled rearward at a stop plate angle relative to the lower portion, the stop plate angle being less than or equal to 45 degrees.

14. (canceled)

15. (canceled)

16. An apparatus for attachment to a shelf including spaced parallel upper and lower front wires, the apparatus comprising:
a connector including a connector wall and an upper partially circular channel extending from the connector wall and configured to receive the upper front wire of the shelf, the connector wall configured to engage the spaced parallel upper and lower front wires of the shelf;
a stop plate receiver integrally formed with the connector and including an upwardly open channel configured to receive a stop plate, the stop plate receiver located forward of the connector;
a product indicia receiver channel integrally formed with the connector and the stop plate receiver, the product indicia receiver channel being located forward of the stop plate receiver and configured to receive product indicia; and
a solid receiver wall defined between the stop plate receiver and the product indicia receiver channel, the solid receiver wall including a receiver side, an indicia side, and a variable thickness defined between the receiver side and the indicia side, the receiver side defining a portion of the stop plate receiver, the indicia side defining a portion of the product indicia receiver channel.

17. (canceled)

18. The apparatus of claim 16, wherein:
the stop plate receiver includes a receiver floor; and
the receiver floor is positioned higher than a lowermost extremity of the connector.

19. The apparatus of claim 17, wherein:
the indicia side is angled upwardly relative to the receiver side.

20. (canceled)

21. (canceled)

22. The apparatus of claim 16, wherein:
the connector includes a lower partially circular channel extending from the connector wall and configured to receive the lower front wire of the shelf.

23. An apparatus for attachment to a shelf including spaced parallel upper and lower front wires, the apparatus comprising:
a connector including a solid connector wall and an upper partially circular channel extending from the solid connector wall and configured to receive the upper front wire of the shelf, the solid connector wall configured to engage the spaced parallel upper and lower front wires of the shelf;
a stop plate receiver integrally formed with the connector and including an upwardly open channel configured to receive a stop plate, the stop plate receiver located rearward of the connector; and
a product indicia receiver channel integrally formed with the connector and the stop plate receiver, the product indicia receiver channel being located forward of the connector and configured to receive product indicia, and
wherein the solid connector wall is defined between the connector and the product indicia receiver channel and includes a connector side, an indicia side, and a variable thickness defined between the connector side and the indicia side, and further wherein the upper partially circular channel extends from the connector side.

24. The apparatus of claim 23, wherein:
the stop plate receiver includes a rear wall of the upwardly open channel extending higher than the upper partially circular channel.

25. The apparatus of claim 23, wherein:
the indicia side is angled upwardly relative to the connector side.

26. the apparatus of claim 23, wherein:
the connector includes a lower partially circular channel extending from the solid connector wall and configured to receive the lower front wire of the shelf.

27. The apparatus of claim 23, further comprising:
the stop plate received in the stop plate receiver, the stop plate including an upper portion and a lower portion, the upper portion angled rearward at a stop plate angle relative to the lower portion, the stop plate angle being less than or equal to 45 degrees.
